(19) United States
(12) Patent Application Publication
(10) Pub. No.: US 2008/0233551 A1
(43) Pub. Date: Sep. 25, 2008

(54) WIRELESS LEARNING SYSTEM

(76) Inventors: Michael Doctoroff, Natick, MA (US); Susan Landay, Newton, MA (US); Richard Eckhardt, Arlington, MA (US)

Correspondence Address: PATRICK R. SCANLON;PRETI FLAHERTY BELIVEAU & PACHIOS LLP, ONE CITY CENTER, PORTLAND, ME, 04112-9546, US

(21) Appl. No.: 12/052,789

(22) Filed: Mar. 21, 2008

Related U.S. Application Data
(60) Provisional application No. 60/919,226, filed on Mar. 21, 2007.

(51) Int. Cl. G09B 3/00

(52) U.S. Cl. 434/352

(57) ABSTRACT

In one embodiment, the present invention provides a wireless learning system that includes a master control unit and a plurality of trigger units. Each trigger unit is able to wirelessly communicate with the master control unit and the other trigger units. Each trigger unit further includes at least one trigger switch and can provide an indication when that trigger unit is the first one of the trigger units to have its trigger switch actuated.

### CROSS REFERENCES TO RELATED APPLICATIONS

This application claims the benefit of U.S. Provisional Application No. 60/919,226, filed Mar. 21, 2007.

### BACKGROUND OF THE INVENTION

The present invention relates generally to “buzz-in” systems that identify an initial respondent from a group of players.

Educators are known to use a game-type teaching tool in which a moderator such as an instructor or schoolteacher provides topical questions, either verbally or visually, to a group of players. Individual members of the group seek to be first to provide a correct answer, thereby providing a fun and interesting learning environment. This type of game is facilitated by providing a system that identifies the first member of the group to “buzz-in.” Typically, such buzz-in or learning systems include a master unit operated by the moderator and a response or trigger unit for each participant of the group. When a participant is the first to actuate his or her trigger unit, an indicator corresponding to that participant lights up on the master unit to identify the participant as the first responder. These systems can use wireless receivers and transmitters that allow signal transmission between the master unit and response units. The signals actuate in the units indicators of game activity such as first response, correctness of response, etc.

These previous wireless learning systems are limited by the number of indicators on the master unit. That is, the number of indicators on the master unit controls the number of participants that can play at a time. For instance, if the master unit has four indicators, no more than four participants can play at the same time.

### SUMMARY OF THE INVENTION

In one embodiment, the present invention provides a wireless learning system that includes a master control unit and a plurality of trigger units. Each trigger unit includes means for wirelessly communicating with the master control unit and the other trigger units. Each trigger unit further includes at least one trigger switch and means for indicating when that trigger unit is the first one of the trigger units to have its trigger switch actuated.

### DESCRIPTION OF THE DRAWINGS

FIG. 1 is a schematic view of a wireless training system.

FIG. 2 is a schematic diagram showing one embodiment of a trigger unit.

FIG. 3 is a top view of one embodiment of a trigger unit.

FIG. 4 is a cross-sectional view of the trigger unit taken along line 4-4 of FIG. 3.

FIG. 5 is a block diagram showing one embodiment of the circuitry for a master control unit.

### DETAILED DESCRIPTION OF THE INVENTION

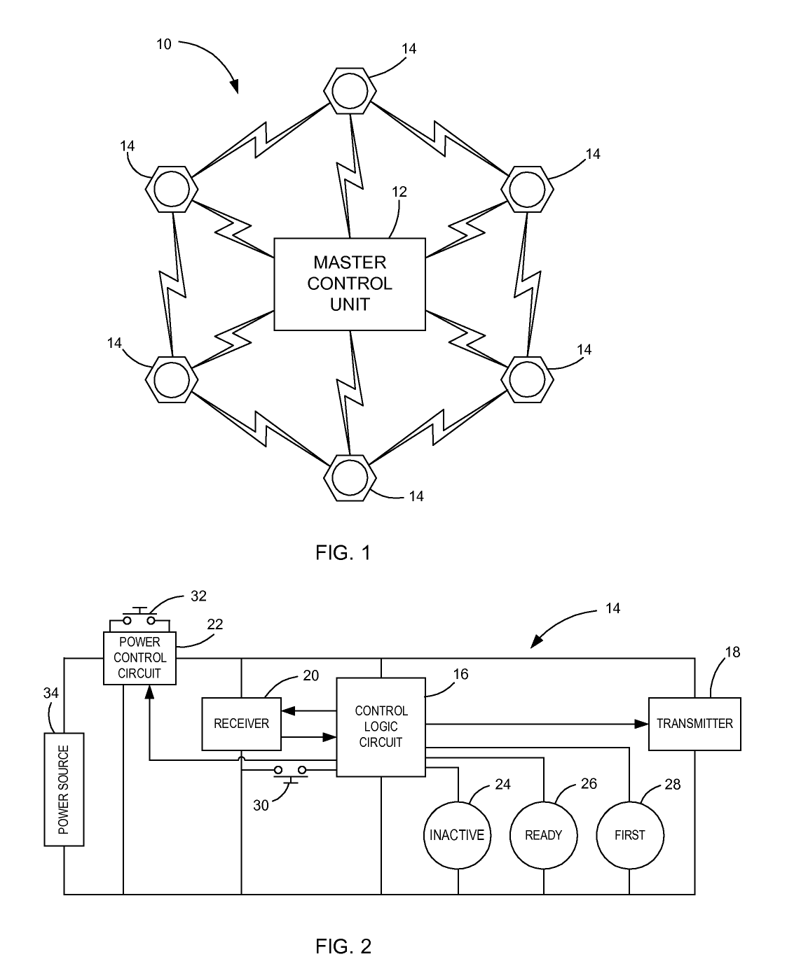

Referring to the drawings wherein identical reference numerals denote the same elements throughout the various views, FIG. 1 shows a wireless buzz-in or learning system 10 comprising a master control unit 12 and a plurality of trigger units 14 that communicate wirelessly, such as via radio frequency (RF) signals, with the master control unit 12 and with each other. The master control unit 12 is used to activate and reset all of the trigger units 14 for game play. As will be described in more detail, each trigger unit 14 has an indicator that indicates if that trigger unit was triggered first. The master control unit 12 thus does not require a number of indicators for identifying the first responder. Accordingly, the system 10 is not limited by the number of indicators on the master control unit 12, meaning that any number of trigger units 14 can be used at the same time with the single master control unit 12.

Turning to FIG. 2, a circuit layout for one embodiment of the trigger units 14 is depicted. Each trigger unit 14 includes a control logic circuit 16, which can be a microprocessor. Each trigger unit 14 further includes a wireless transmitter 18, a wireless receiver 20, and a power control circuit 22, which are all connected to the control logic circuit 16. It should be noted that the power control function does not need to be a separate module. The power control circuit 22 can be incorporated into the control logic circuit 16, particularly where the control logic circuit 16 is a low power microprocessor or has a low power mode so that power does not have to be removed when the unit 14 is not being used. An “inactive” indicator 24, a “ready” indicator 26, and a “first” indicator 28 are also connected to the control logic circuit 16. The trigger unit 14 also has at least one trigger switch 30 connected to the control logic circuit 16. While only one trigger switch 30 is shown in FIG. 2, it should be noted that several trigger switches could be provided. A power switch 32 is connected to the power control circuit 22. When actuated, the power switch 32 causes the power control circuit 22 to turn on the power if the trigger unit 14 is off. A power source 34, which can typically comprise one or more batteries, is also provided.

The control logic circuit 16 is used to interpret signals received from the receiver 20 and the trigger switches 30, to control the indicators 24, 26, 28, and to control signals transmitted by the transmitter 18, which can be turned on by a control signal from the control logic circuit 16. The control logic circuit 16 interprets encoded signals from the master control unit 12 to perform the appropriate functions and place the trigger unit 14 in the correct operating mode. To conserve power, the control logic circuit 16 also includes a power-off timer that provides an automatic shutdown after a predetermined period (such as five minutes) of inactivity and can also turn off the receiver 20 when the receiver 20 is not required.

The transmitter 18 and the receiver 20 can use any form of wireless communication, including radio frequency (RF). For example, the receiver 20 can be an RF receiver, and the wireless transmitter 18 can be a continuous wave RF transmitter that is tuned to the same frequency as the receiver 20. The transmitters 18 and receivers 20 of all of the trigger units 14 in the system 10 will be tuned to the same frequency. The receiver 20 provides a logic signal to the control logic circuit 16 whenever a received signal is detected, and a modulated or encoded signal will result in a series of logic level outputs to the control logic circuit 16. To conserve power in operating modes for which the receiver 20 is not needed, a control signal from the control logic circuit 16 can turn off the receiver 20.

The “inactive” indicator 24, the “ready” indicator 26, the “first” indicator 28 can each be in the form of a light source, such as a light emitting diode (LED). In one embodiment, the “ready” indicator 26 is a high-brightness (for low current operation), narrow viewing angle (e.g., 20 degrees or less) LED that lights continuously when the trigger unit 14 is in its “ready” mode, and the “inactive” indicator 24 is a high-brightness (for low current operation), narrow viewing angle (e.g., 20 degrees or less) LED that lights continuously when the trigger unit 14 is in its “inactive” mode. The “first” indicator 28 comprises a plurality of high-brightness, wide viewing angle LEDs that cause the entire top of the trigger unit 14 to glow brightly when lit. These LEDs are activated when the particular trigger unit 14 is the first activated by a user after being enabled by a signal from the master control unit 12. The LEDs of the three indicators are preferably different colors so that they can be differentiated. For example, the “ready” indicator 26 can be a green LED, the “inactive” indicator 24 can be a yellow LED, and the “first” indicator 28 can comprise red LEDs.

The power control circuit 22 is designed to limit the current consumption of the trigger unit 14 to less than a predetermined level when the trigger unit 14 is in its “Off” mode. For instance, the predetermined level typically will be 1-10 microamps when the power source 34 comprises very small batteries such as CR2032 lithium coin cells. When the power source 34 comprises larger batteries, such as AAA or AA cells, the predetermined level typically will be higher, such as 100 microamps. When actuated, the power switch 32 on the power control circuit 22 provides power to the control logic circuit 16 for several seconds to allow the control logic circuit 16 to initialize and then provide a power-on signal to the power control circuit 22. After a specified period (five minutes for example) of inactivity, the control logic circuit 16 removes the power-on signal and power is shut down.

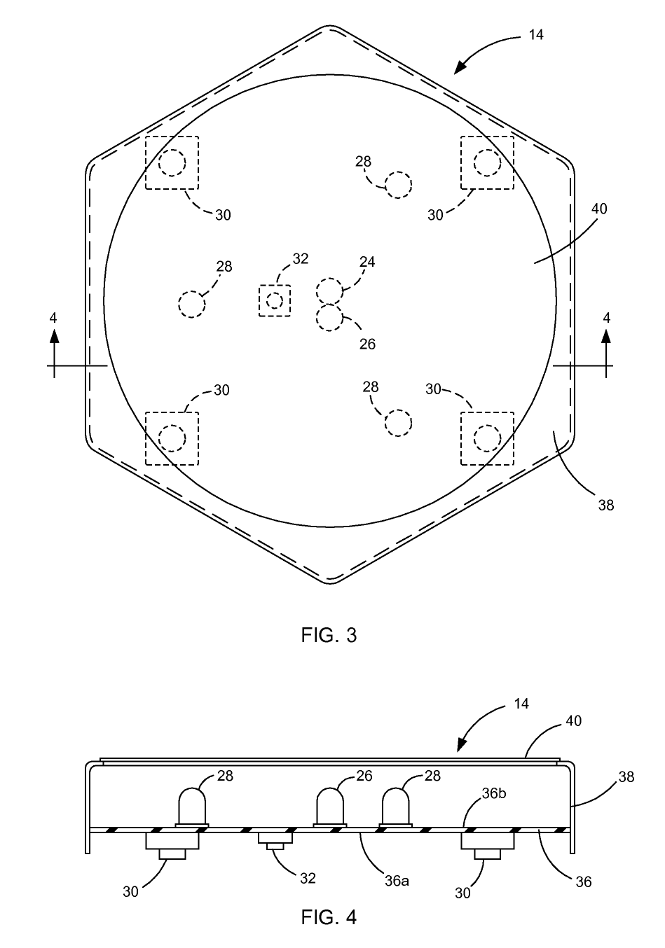

The mechanical configuration of a trigger unit 14 is illustrated in FIGS. 3 and 4. In the illustrated embodiment, the trigger unit 14 includes a base 36 having a bottom surface 36a and an upper surface 36b and a cover 38 mounted to the base 36 so as to enclose the upper surface 36b. The base 36 is set back slightly from the lower edge of the cover 38 so as to define a recess on the underside of the trigger unit 14. The trigger unit 14 is shown as having a hexagonal shape, but the present invention is not limited to this shape and can have a wide variety of shapes. A translucent window 40 is formed on the top of the cover 38. As an alternative to the flat window shown in FIG. 4, the window 40 can be dome-shaped so as to be more visible to other participants when lit. The base 36, which can be a printed circuit board, supports the control logic circuit 16, the transmitter 18, the receiver 20, and the power control circuit 22 (not shown in FIGS. 3 and 4). In this embodiment, the indicators 24, 26, 28 comprise colored LEDs mounted on the upper surface 36b of the base 36 so as to be visible through the translucent window 40. The “ready” indicator 26 is a green LED, and the “inactive” indicator 24 is a yellow LED. These two LEDs 24, 26 are positioned next to each other at the center of the base 36. The “first” indicator 28 comprises three red LEDs spaced equally about the base 36 at locations approximately midway from the center of the base 36. The red “first” LEDs 28 are high-brightness, wide viewing angle LEDs for maximum illumination of the window 40, while the green and yellow LEDs 24, 26 are high-brightness, narrow viewing angle LEDs, operated at low current, that illuminate a small spot in the center of the window 40 when activated. The window 40 is designed to diffuse light, so that when the three “first” LEDs 28 are lit, most of the window 40 is glowing.

As shown in FIGS. 3 and 4, four trigger switches 30 are mounted on the bottom surface 36a of the base 36. The trigger switches 30 are pushbutton switches that are long enough so as to protrude beyond the lower edge of the cover 38 and thus form the “feet” of the trigger unit 14. That is, the trigger switches 30 can support the trigger unit 14 on a surface. The weight of the trigger unit 14 will not actuate any of the trigger switches 30, but any or all of the trigger switches 30 are actuated when a user presses the entire unit 14 down a sufficient distance. (As an alternative to four trigger switches 30 on the bottom, the trigger unit 14 could have a button on the top of the unit 14 that actuates one switch.) The power switch 32 is also mounted on the bottom surface 36a of the base 36, but is shorter than the trigger switches 30 and does not protrude beyond the lower edge of the cover 38. The power switch 32, which can also be a pushbutton switch, is thus not activated when the trigger unit 14 is pressed down, but can be manually operated after turning the unit 14 over.

Each of the trigger units 14 has four operating modes, referred to herein as the “Off,” “Inactive,” “Ready,” and “First” modes. In the “Off” mode, the trigger unit 14 is completely inactive with none of the indicators 24, 26, 28 activated, and the unit 14 does not send or receive wireless signals. The only action that can be done in the “Off” mode is to turn on the unit 14 by activating the power switch 32, which switches the unit 14 into “Inactive” mode.

In the “Inactive” mode, power is applied to the control logic circuit 16, the “inactive” indicator 24 is on, and the receiver 20 is operating and “listening” for encoded signals from the master control unit 12. The transmitter 18 is not active or used in this mode. If a reset signal is received from the master control unit 12, the trigger unit 14 switches to the “Ready” mode, and if one or more of the trigger switches 30 are activated when a reset or continue signal is received from the master control unit 12, the trigger unit 14 remains in the “Inactive” mode. The power-off timer is running in this mode and is reset whenever a wireless signal is received, or when a trigger switch 30 is activated. The trigger unit 14 will be switched to “Off” mode if the power-off timer reaches the predetermined period (e.g., five minutes) or if a power-off signal is received from the master control unit 12.

In the “Ready” mode power is applied to the control logic circuit 16, the “ready” indicator 26 is on, and the receiver 20 is operating and “listening” for signals from the other trigger units 14 in the system 10. If a wireless alert signal is received from one of the other trigger units 14 before any one of its trigger switches 30 is activated, the trigger unit 14 will be switched to the “Inactive” mode. If one of trigger switches 30 is activated before a wireless alert signal is received, the trigger unit 14 will switch to the “First” mode and send out a short (typically less than one second) alert signal via the transmitter 18 that alerts the other trigger units in the system 10 that this trigger unit 14 is the first responder. The power-off timer is running in this mode and is reset whenever a wireless signal is received, or when one of the trigger switches 30 is activated. The unit 14 will be switched to the “Off” mode if the power-off timer reaches the predetermined period (e.g., five minutes) or if a power-off signal is received from the master control unit 12.

In the “First” mode, power is applied to the control logic circuit 16 and the “first” indicator 28 is on. In one embodiment, the “first” indicator 28 comprises LEDs that blink when activated. For example, the “first” LED can blink approximately twice per second with an on-time of approximately 80%. In this mode, the transmitter 18 is off and the receiver 20 is operating and “listening” for encoded signals from the master control unit 12. If a reset signal is received, the trigger unit 14 switches to the “Ready” mode. If a continue signal is received, the unit 14 switches to the “Inactive” mode. The trigger switches 30 in the unit 14 are ignored in the “First” mode except to reset the power-off timer, which is running in this mode. The power-off timer is reset whenever a wireless signal is received or when a trigger switch 30 is activated. The unit 14 will be switched to the “Off” mode if the power-off timer reaches the predetermined period (e.g., five minutes) or if a power-off signal is received from the master control unit 12.

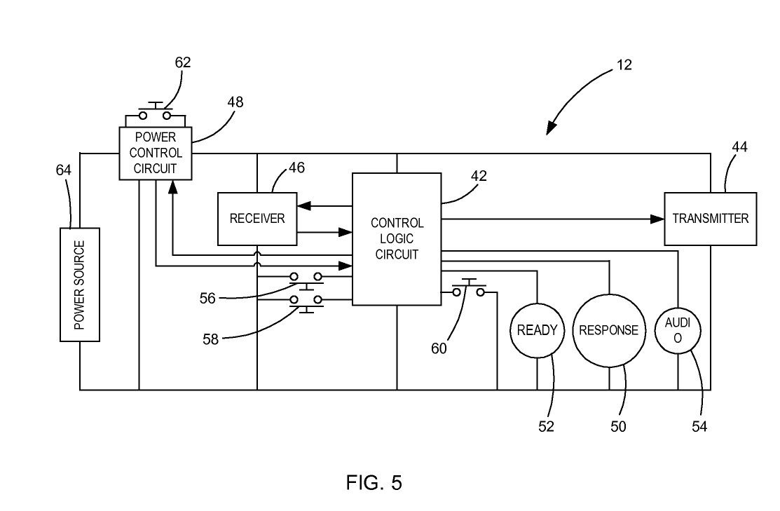

Turning to FIG. 5, a circuit layout for one embodiment of the master control unit 12 is depicted. The master control unit 12 includes a control logic circuit 42, which can be a microprocessor. The master control unit 12 further includes a wireless transmitter 44, a wireless receiver 46, and a power control circuit 48, which are all connected to the control logic circuit 42. The control logic circuit 42 can be either a separate module or incorporated in the control logic circuit 42. A “response” indicator 50, a “ready” indicator 52, and an audio signaling device 54 (such as a piezoelectric beeper) are also connected to the control logic circuit 42. The master control unit 12 also has a reset switch 56, a continue switch 58, and a mute/volume switch 60 connected to the control logic circuit 42. A power switch 62 is connected to the power control circuit 48. All of these switches can be in the form of pushbutton switches. When actuated, the power switch 62 causes the power control circuit 48 to turn on the power if the master control unit 12 is off. A power source 64, which can typically comprise one or more batteries, is also provided.

The control logic circuit 42 is used to interpret signals received from the receiver 46 and the switches 56, 58, 60, to control the “response” indicator 50, the “ready” indicator 52, and the audio device 54, and to control signals transmitted by the transmitter 44. The control logic circuit 42 creates encoded signals for various functions and sends them to the transmitter 44, which transmits the encoded signals to place the trigger units 14 in the correct operating mode. The control logic circuit 42 receives signals from the receiver 46 to determine if there has been a user response and then controls the response indicator 50 and the audio device 54 accordingly. The control logic circuit 42 also includes a power-off timer that provides an automatic power shutdown after a predetermined period (such as five minutes) of inactivity. The control logic circuit 42 can also turn off the receiver 46 to conserve power.

The transmitter 44 and the receiver 46 can use any form of wireless communication, including radio frequency (RF). For example, the receiver 46 can be an RF receiver, and the wireless transmitter 44 can be a continuous wave RF transmitter that is tuned to the same frequency as the receiver 46. The transmitter 44 and the receiver 46 are also tuned to the same frequency as the transmitters 18 and receivers 20 of all of the trigger units 14. The transmitter 44 is turned on by a control signal from the control logic circuit 42. When an encoded signal is sent, the control logic circuit 42 rapidly modulates the transmitter 44 to create a pattern that can be recognized as a specific command by the trigger units 14. The command sequence is typically repeated a number of times to assure reliable reception. The receiver 46 provides a logic signal to the control logic circuit 42 whenever a received signal is detected. This can provide an indication when there is a response from one of the trigger units 14, causing the control logic circuit 42 to activate the “response” indicator 50 and to cause the audio device 54 to emit a short auditory signal (such as a beep) if it has not been muted. A control signal from the control logic circuit 42 can turn off the receiver 46 to conserve power in modes where the receiver 46 is not needed.

The reset and continue switches 56, 58 are mounted on an external surface of the master control unit 12. These switches 56, 58 are activated by the user to initiate the control commands. The reset switch 56 triggers the control logic circuit 42 to transmit an encoded reset signal, while the continue switch 58 triggers the control logic circuit 42 to transmit an encoded continue signal. The mute/volume switch 60 is also mounted on an external surface of the master control unit 12 and is used to turn the audio device 54 on or off or control its volume. The power switch 62, which is mounted on an external surface (typically the bottom) of the master control unit 12, triggers the power control circuit 48 to turn on the power if the master control unit 12 is off. The power switch 62 can also be used to turn the power off if the unit 12 is on. In this case, the master control unit 12 can transmit a power-off signal to all the trigger units 14 before turning off its own power.

The “response” indicator 50 and the “ready” indicator 52 can each be in the form of a light source, such as a light emitting diode (LED). In one embodiment, the “ready” indicator 52 is a green LED that is lit continuously when the master control unit 12 is on and ready for operation, while the “response” indicator 50 is an LED (typically of a different color such as red) that is turned on when a wireless signal from a trigger unit 14 is detected. The “response” indicator 50 is turned off when a user actuates either of the reset or continue switches 56, 58. The audio device 54 produces an auditory signal when the “response” indicator 50 is first turned on, if it has not been muted via the mute/volume switch 60, and can also be used to produce a very short beep or tweet when a button is pressed to confirm activation.

The power control circuit 48 limits the current consumption of the master control unit 12 when it is not operating. The power switch 62 on the power control circuit 48 provides power to the control logic circuit 42 for several seconds to allow the control logic circuit 42 to initialize and then provide a power-on signal to the power control circuit 48. After a predetermined period (five minutes for example) of inactivity, the control logic circuit 42 removes the power-on signal and power is shut down. If the power switch 62 is held down more than a given period, such as one second, the master control unit 12 will first transmit an encoded signal to the trigger units 14 that would cause them to switch to the “Off” mode, and then the master control unit 12 switches to its “Off” mode. In its “Off” mode, the master control unit 12 is completely inactive with neither of the indicators 50, 52 activated, and the master control unit 12 does not send or receive wireless signals. The only action that can be done in this mode is to turn on the master control unit 12 by activating the power switch 62, which switches the master control unit 12 into its “Operating” mode.

In the “Operating” mode, power is applied to the control logic circuit 42. The “ready” indicator 52 is on, the “response” indicator 50 is initially off, and the wireless receiver 46 is operating and “listening” for signals from the trigger units 14. If a wireless signal is received, the audio device 54 is activated for a short period, such as approximately one second, (if it has not been muted), and the “response” indicator 50 is turned on and stays on until the reset switch 56 or the continue switch 58 is actuated. If additional wireless signals are received after the “response” indicator 50 is turned on, the audio device 54 is not re-activated. Actuating the reset switch 56 turns off the “response” indicator 50 and causes an encoded reset signal to be transmitted via the transmitter 44 to the trigger units 14. Actuating the continue switch 58 turns off the “response” indicator 50 and causes an encoded continue signal to be transmitted via the transmitter 44. Actuating the power switch 62 more than a given period, such as one second, while in the “Operating” mode causes an encoded power-off signal to be transmitted to the trigger units 14 to switch them to the “Off” mode, and the master control unit 12 is also switched to its “Off” mode.

Signals from the wireless receiver 46 are ignored during the transmission of the encoded control signals, and actuating the mute/volume switch 60 causes the master control unit 12 to either toggle between muted and non-muted modes and/or to cycle through a number (such as four for example) of volume levels of which one is off. In the latter case, each press of the mute/volume switch 60 causes the audio device 54 to sound at the designated volume level. The power-off timer is running in this mode and is reset whenever a switch is activated. The master control unit 12 will be switched to “Off” mode if the power-off timer reaches a predetermined period (e.g., five minutes).

In operation, the master control unit 12 and the trigger units 14 are activated. To start a game, an encoded reset signal is sent from the master control unit 12 and is received by all of the trigger units 14. When the trigger units 14 receive this signal, they are initialized for game play. The “ready” indicator 26 is then activated on each trigger unit 14. When each trigger unit 14 is in the “Ready” mode, its wireless receiver 20 is also activated to “listen” for any signals from the other trigger units 14. In this ready condition, the first trigger unit 14 to be activated by a user sends out a wireless alert signal (which can be a continuous signal without encoding). This trigger unit 14 also activates its “first” indicator 28 to indicate that it was the first trigger unit to be activated.

When the other trigger units 14 receive the alert signal from the first unit 14 activated, they are disabled (i.e., switched to the “Inactive” mode), so that user activation will not turn on their “first” indicators 28. The “ready” indicator 26 of the other trigger units 14 is turned-off, and their “inactive” indicators 24 are turned on, when the alert signal from the first activated trigger unit 14 is received. With this configuration, any number of trigger units 14 can be used, but only the first one activated will have its “first” indicator 28 turned on. The wireless receiver 46 of the master control unit 12 also receives the signal from the first trigger unit 14 activated. When the master control unit 12 receives this signal, the “response” indicator 50 is turned on and the audio device 54 (if it has not been muted) emits a short auditory signal to indicate that a response has been made. This indication alerts the teacher/moderator that a response has been made, or in its absence, that no one responded.

If the round of game play is to continue from this point (for example, if the first responder did not have the correct answer) then the user actuates the continue switch 58, which causes an encoded continue signal to be transmitted from the master control unit 12. All the trigger units 14 except the one that has its “first” indicator 28 turned on are reset to continue the game. The trigger unit 14 that has its “first” indicator 28 turned on is switched to the “Inactive” mode with its “inactive” indicator 24 on until a reset signal is sent from the master control unit 12. The round of game play can now continue and the next first responder's unit 14 will send out a wireless signal to the other trigger units 14 and will activate its “first” indicator 28. The other trigger units 14 will be disabled again by the signal transmitted from this first responder. If the switch on a trigger unit 14 is activated when a continue or reset signal is received, this is considered a “foul” and that unit 14 will be switched to “Inactive” mode without transmitting a signal. When this round of game play is complete, the user actuates the reset switch 56, and the master control unit 12 sends a reset signal to all the trigger units 14 to start a new round. This reset signal reactivates all the trigger units 14 for the next round of game play.

While specific embodiments of the present invention have been described, it should be noted that various modifications thereto could be made without departing from the spirit and scope of the invention as defined in the appended claims.

What is claimed is:

1. A wireless learning system comprising:
a master control unit; and
a plurality of trigger units, each trigger unit comprising:
means for wirelessly communicating with said master control unit and the other trigger units of said plurality of trigger units;
at least one trigger switch; and
means for indicating when said trigger unit is the first one of said plurality of trigger units to have its trigger switch actuated.

2. The wireless learning system of claim 1 wherein said means for wirelessly communicating sends out an alert signal to said master control unit and the other trigger units when said trigger unit is the first one of said plurality of trigger units to have its trigger switch actuated.

3. The wireless learning system of claim 1 wherein each trigger unit further comprises means for indicating when said trigger unit is operating and ready to receive signals from the other trigger units.

4. The wireless learning system of claim 1 wherein each trigger unit further comprises means for indicating when said trigger unit is operating and ready to receive signals from said master control unit.

5. The wireless learning system of claim 1 wherein each trigger unit further comprises a power source.

6. The wireless learning system of claim 5 wherein each trigger unit further comprises a means for shutting down power after a predetermined period of inactivity.

7. The wireless learning system of claim 1 wherein each trigger unit further comprises a base having a bottom surface and an upper surface and a cover mounted to said base so as to enclose said upper surface.

8. The wireless learning system of claim 7 wherein said trigger switch is a pushbutton switch mounted to said bottom surface of said base and protruding beyond a lower edge of said cover.

9. The wireless learning system of claim 7 wherein said means for indicating comprises a first light source mounted on said upper surface of said base.

10. The wireless learning system of claim 9 wherein each trigger unit further comprises a second light source mounted on said upper surface of said base for indicating when said trigger unit is operating and ready to receive signals from the other trigger units, and a third light source mounted on said upper surface of said base for indicating when said trigger unit is operating and ready to receive signals from said master control unit.

11. The wireless learning system of claim 10 wherein said first, second and third light sources are different colors.

12. The wireless learning system of claim 10 wherein each trigger unit further comprises a window formed on said cover.

13. The wireless learning system of claim 1 wherein said master control unit includes means for wirelessly communicating with said plurality of trigger units.

14. The wireless learning system of claim 13 wherein said master control unit includes means for providing an indication of when one of said plurality of trigger units has its trigger switch actuated.

15. The wireless learning system of claim 14 wherein said means for providing an indication includes a light source and an audio device.

16. The wireless learning system of claim 15 wherein said master control unit includes means for muting said audio device.

17. The wireless learning system of claim 13 wherein said master control unit includes means for sending continue and reset signals to said plurality of trigger units.
